(19) United States
(12) Patent Application Publication
(10) Pub. No.: US 2009/0043448 A1
(43) Pub. Date: Feb. 12, 2009

(54) Operating Method and Operating System for a Vehicle

(75) Inventors: Metta Boger, Aidlingen (DE); Guenter Metsch, Moeglingen (DE); Roland Pregizer, Pliezhausen (DE); Dietmar Scheer, Stuttgart (DE); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/994,045

(22) PCT Filed: Jun. 27, 2006
(86) PCT No.: PCT/EP2006/006177

§ 371 Date: Jun. 4, 2008

(30) Foreign Application Priority Data
Jun. 29, 2005 (DE) 10 2005 030 180.0

(51) Int. Cl. G06F 19/00

(52) U.S. Cl. 701/36

(57) ABSTRACT

An operating method for a vehicle having at least one toggle switch with which, when it is activated, it is possible to change between at least two assigned applications or application groups, and an associated operating system. After activation of the toggle switch has been detected, activation states of at least two assigned applications or application groups are determined, and at least one of the assigned applications or application groups is activated as a function of the determined activation states. A predefined basic state of a predefined application or application group or a stored last state of an application or application group which is activated last is set if all the applications or application groups which are assigned to the toggle switch are in a first state.

### BACKGROUND AND SUMMARY OF THE INVENTION

This application is a national stage of PCT International Application No. PCT/EP2006/006177, filed Jun. 27, 2006, which claims priority under 35 U.S.C. § 119 to German Patent Application No. 10 2005 030 180.0, filed Jun. 29, 2005, the disclosure of which is expressly incorporated by reference herein.

The invention relates to an operating method and an associated operating system for a vehicle.

Multimedia operating systems are being increasingly used in modern vehicles. The COMAND system in the Mercedes Benz S class is an example of this. In such an operating system, a plurality of menu levels are displayed on a screen display in a menu structure and can comprise a plurality of display areas on the screen display. The menu structure is operated using manual activation devices which are embodied, for example, as what are referred to as toggle switches which are arranged, for example, on a multifunction steering wheel. By activating the toggle switch it is possible to change between a plurality of menu items, applications, functions, subfunctions and/or options, for example in a predefined annular sequence.

One object of the present invention is to define different applications which are run through in the predefined sequence, for example the changeover between the various radiofrequency bands AM-FM-MW-LW.

In addition, it is known to use two toggle switches which run through the annular sequence of applications in respective different directions. In this way it is possible, for example, for there to be an upward or plus key or a downward or minus key on the multifunction steering wheel. In a conventional operating method with toggle switches it is possible to differentiate two cases. If, for example in a first case, one of the plurality of applications is active when the toggle switch is activated, the system jumps to the next application. If, in a second case, none of the applications is active, the toggle switch has no function.

Furthermore, the toggle switches can be used on different menu levels. It is thus possible, for example, to use a first toggle switch pair in a first menu level for selecting one of a plurality of basic applications, and a second toggle switch pair can be used to select and/or set predefined applications or parameters in a second menu level.

One-jump switches, which after activation activate an application or an application group, are known from the prior art, with a stored last state or a predefined basic state of the corresponding application or application group being set. If a stored last state is set, the predefined basic state of the corresponding application and/or application group can be activated by a second activation of the one-jump switch. In order to activate the basic state it is also possible to predefine a specific type of activation, for example activation of the one-jump switch for a predefined time period.

In German laid-open patent application DE 199 41 947 A1, operating elements for a combination instrument and a central display are described, wherein the operating elements are integrated into a steering wheel of a motor vehicle. One of the operating elements is embodied as a rocker switch with a toggle key, it being possible to use the toggle switch to activate and/or deactivate the combination instrument or return it to a basic state. With the rocker switch a user can change between different menu representations after the activation of the combination instrument. A further operating element is used to accept an incoming telephone call or to end an accepted telephone call.

One object of the present invention is to make available an operating method and associated operating system for a vehicle which increases the operating convenience and promotes intuitive operator control.

This and other objects and advantages are achieved by the method according to the invention, in which the operating method according to the invention advantageously integrates the properties of a one-jump switch into a toggle switch so that the one-jump switch can be eliminated.

After activation of a toggle switch has been detected activation states of at least two applications or application groups which are assigned to the toggle switch are determined in an operating method for a vehicle, and one of the assigned applications or application groups is activated. A predefined basic state of a predefined application or application group or a stored last state of a last activated application or application group is set if all the applications or application groups which are assigned to the toggle switch are in a first state.

In one refinement of the inventive method, the first state of an application or application group is detected. For example, if the associated application or application group is deactivated, a second state of an application or application group is detected if the associated application or application group is activated, and a third state of an application or application group is detected if the application or application group is an audio application which is making a continuous audio output.

By way of example, if one of the applications or application groups which is assigned to the toggle switch is in a second state, an application or application group is activated which is arranged in a predefined sequence after the application or application group which is instantaneously activated, wherein the instantaneously activated application or application group is deactivated. This applies if the toggle switch runs through a predefined sequence of the assigned applications or application groups in a rising annular order.

Alternatively, if one of the applications or application groups which are assigned to the toggle switch is in a second state, an application or application group which is arranged in a predefined sequence before the application or application group which is instantaneously activated is activated. This applies if the toggle switch runs through a predefined sequence of the assigned applications or application groups in a descending annular order.

If it is detected, for example, that one of the applications or application groups which are assigned to the toggle switch is in the third state and none of the applications or application groups which are assigned to the toggle switch is in the second state, the application or application group which is in the third state is activated.

In a further refinement of the operating method according to the invention, the activated application or application group is displayed for operator control on at least one optical display unit.

The applications or application groups which are assigned to at least one toggle switch include, for example, a radio application, disk application, a multimedia application, a navigation application, a video application, a CD application, a DVD application, a TV application, a telephone application, an e-mail application and/or an address book application.

The associated operating system for a vehicle for carrying out the method according to the invention comprises at least one toggle switch with which it is possible to change between at least two applications or application groups which are assigned to the toggle switch. The operating system includes an evaluation and control unit which, after activation of the toggle switch has been detected, determines the state of at least two applications or application groups which are assigned to the toggle switch and activates at least one of the assigned applications or application groups as a function of the determined activation states of at least two assigned applications or application groups. The evaluation and control unit sets a predefined basic state of a predefined application or application group or a stored last state of a last activated application or application group if all the applications or application groups which are assigned to the toggle switch are in a first state.

In one refinement of the operating system, there are, for example, two toggle switches which are each assigned the same applications or application groups, wherein a first toggle switch runs through in rising order the assigned applications or application groups which are arranged in a predefined sequence, and a second toggle switch runs through in descending order the assigned applications or application groups which are arranged in a predefined sequence.

In a further refinement, the operating system comprises a screen for displaying the activated application or application group and an audio system for making a continuous audio output of an audio application.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a block circuit diagram of an operating system for a vehicle,

FIGS. 2 to 4 show a flowchart of a first exemplary embodiment of an operating method according to the invention, and

FIGS. 5 and 6 show a flowchart of a second exemplary embodiment of the operating method according to the invention.

### DETAILED DESCRIPTION OF THE DRAWINGS

FIG. 1 shows an example of an operating system 1 for a vehicle that includes at least one screen 2 for displaying an activated application or application group, at least one toggle switch 31, 32 with which it is possible to change between at least two applications 51, 52, 53, 54 which are assigned to the toggle switch 31, 32, an evaluation and control unit 4 which, after activation of the toggle switch 31, 32 has been detected, determines the state of the at least two applications 51, 52, 53, 54 which are assigned to the toggle switch 31, 32, and activates at least one of the assigned applications 51, 52, 53, 54 as a function of the determined activation states, and an audio system 6 for the continuous audio output of an audio application. The application or application group is referred to below only as an application, for the sake of simplicity.

The evaluation and control unit 4 detects, for example, a first state of an application 51, 52, 53 or 54 if the associated application 51, 52, 53 or 54 is deactivated, wherein the evaluation and control unit 4 detects a second state of an application 51, 52, 53 or 54 if the associated application 51, 52, 53 or 54 is activated, and detects a third state of an application 51, 52, 53 or 54 if the application is an audio application which is making a permanent audio output.

If the evaluation and control unit 4 determines that all the applications 51, 52, 53, 54 which are assigned to the toggle switches 31, 32 are in the first state, the evaluation and control unit 4 sets a predefined basic state of a predefined application or a stored last state of a last activated application.

If the evaluation and control unit 4 determines that an application 51, 52, 53 or 54 which is assigned to the toggle switches 31, 32 is in the second state, an application which is arranged in a predefined sequence after the instantaneously active application is activated if the first toggle switch 31 has been activated. If the second toggle switch 32 has been activated, an application which is arranged in the predefined sequence before the instantaneously active application is activated if the evaluation and control unit 4 determines that an application 51, 52, 53 or 54 which is assigned to the toggle switches 31, 32 is in the second state. In addition, the instantaneously active application is deactivated by the evaluation and control unit. In conjunction with the present invention, an active application is an application which is displayed for operator control on the at least one screen display 2.

If the evaluation and control unit 4 determines that one of the applications 51, 52, 53, 54 which is assigned to the toggle switches 31, 32 is in the third state and none of the applications 51, 52, 53, 54 which is assigned to the toggle switch 31, 32 is in the second state, the application which is in the third state is activated.

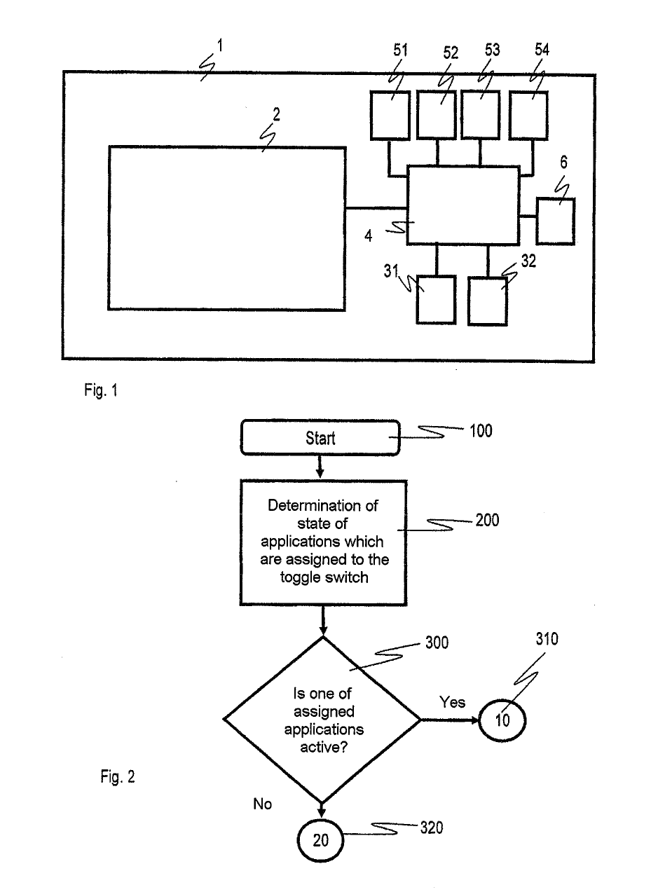

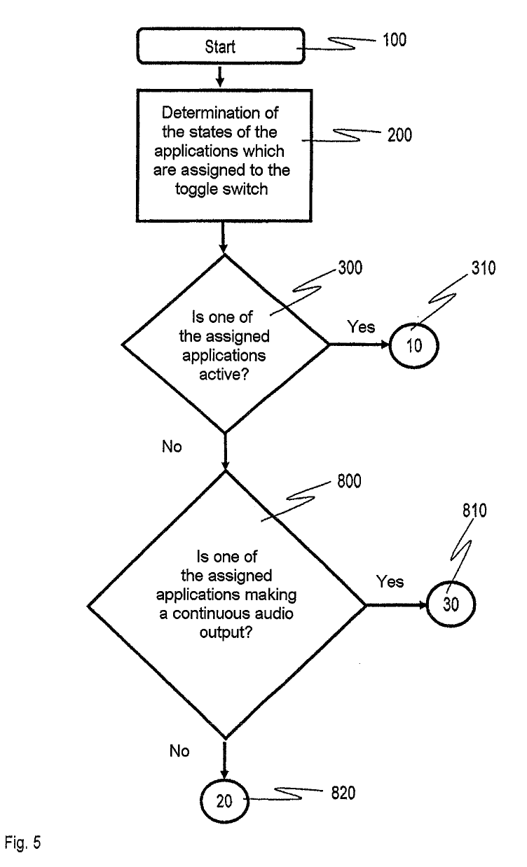

FIGS. 2 and 5 are examples of the embodiments of the operating method. In the operating method for a vehicle having at least one toggle switch 31, 32 the method is started in step 100 by detected activation of one of the toggle switches 31, 32. The operating method can basically be divided into two embodiments. In the first embodiment which is illustrated in FIG. 2, the applications which are assigned to the one or more toggle switches 31, 32 do not comprise applications with a continuous audio output via the audio system 6. In a second embodiment which is illustrated in FIG. 5, the applications which are assigned to the one or more toggle switches 31, 32 comprise at least one audio application with continuous audio output via the audio system 6.

An application which can be heard in the vehicle via the audio system 6, for example, via loudspeakers, is referred to as an “active audio application”. The application which can be seen on the screen display 2 is referred to as an “active application”, in which case the “active application” can be different from the “active audio application”.

When the “active application” is selected, the selected application automatically also becomes an “active audio application” if the selected application has continuous audio output. Applications with continuous audio output are, for example, all the audio and video applications which are present in the vehicle and which comprise corresponding off states or other switched-off audio/video states such as, for example, “no CD present”. In addition, an application is also understood to be application groups, functions, subfunctions, etc. between which it is possible to change using at least one toggle switch 31, 32.

Last set or last activated application is also understood to be an application which has not been activated by means of one of the toggle switches 31, 32 but rather by means of a menu control or in some other way. The described method therefore constitutes an additional activation possibility for the existing applications in the vehicle, with the various application methods being able to be used in parallel.

FIG. 2 shows that after activation of one of the toggle switches 31, 32 has been detected the operating method according to the invention is started in step 100. Then, in step 200 the states of the applications 51 to 54 which are assigned to the toggle switches 31, 32 are determined. According to the embodiment in FIG. 2, the applications 51 to 54 do not have any permanent audio output. However, temporary audio outputs, for example short navigation announcements or the ringing of a telephone or the use of the telephone in hands-free mode, may also be possible. In step 300, it is then checked whether one of the assigned applications 51 to 54 is active.

If the checking of the applications 51 to 54 reveals that no application 51 to 54 is active, in step 320 the system branches to the node 20 in FIG. 4. As is apparent from FIG. 4, the activation of one of the toggle switches 31, 32 which was detected before step 100, leads into step 700 to activation of a predefined application, for example the application 51, or to activation of an application which was used last by the applications 51 to 54. The method is then ended in step 600 until renewed activation occurs as a result of activation of one of the toggle switches 31, 32.

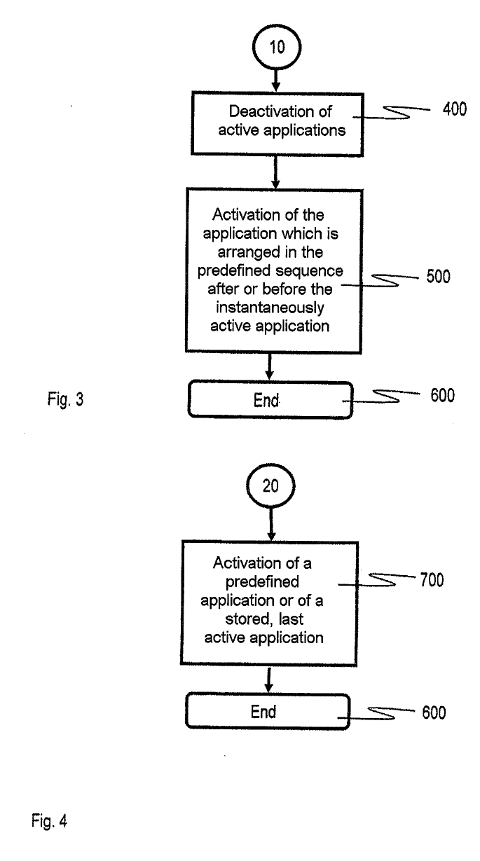

If the checking of the applications 51 to 54 in step 300 reveals that one of the applications 51 to 54 is active, in step 310 the system branches to the node 10 in FIG. 3. As is apparent from FIG. 3, in step 400 the instantaneously activated application is deactivated, for example the application 52. In step 500, the application 53 which is arranged after the instantaneously active application 52 in the predefined sequence is activated if activation of the first toggle switch 31 is detected before the step 100. If activation of the second toggle switch 32 is detected before the step 100, the application 51 which is arranged in the predefined sequence before the instantaneously active application 52 is activated in step 500. The method is then ended in step 600 up to renewed activation by activation of one of the toggle switches 31, 32.

In an exemplary embodiment which is not illustrated, for example only two applications A and B are assigned to a toggle switch. Activation of the toggle switch then activates the respective other application if one of the applications is active. If A is the active application, activation of the toggle switch leads to activation of the application B, for example. If one of the applications is active, either a predefined application, for example the application A is activated when the toggle switch is activated, or the last activated application is activated again.

As is apparent from FIG. 5, after activation of one of the toggle switches 31, 32 has been detected the operating method according to the invention is started in step 100, in a way analogous to the method from FIG. 2. Then, in step 200 the states of the applications 51 to 54 which are assigned to the toggle switches 31, 32 are determined. According to the embodiment from FIG. 5, the applications 51 to 54 have continuous audio outputs such as, for example, a radio application, CD application or a television application. In step 300, it is then checked whether one of the assigned applications 51 to 54 is active.

If the checking of the applications 51 to 54 in step 300 reveals that one of the applications 51 to 54 is active, in step 310 the system branches to the node 10 in FIG. 3 in a way which is analogous to FIG. 2. As is apparent from FIG. 3, in step 400 the instantaneously activated application is deactivated, for example, the application 52. In step 500, the application 53 which is arranged after the instantaneously active application 52 in the predefined sequence is activated if activation of the first toggle switch 31 is detected before the step 100. If activation of the second toggle switch 32 is detected before the step 100, in step 500 the application 51 which is arranged before the instantaneously active application 52 in the predefined sequence is activated. The method is then ended in step 600 up to renewed activation by activation of one of the toggle switches 31, 32.

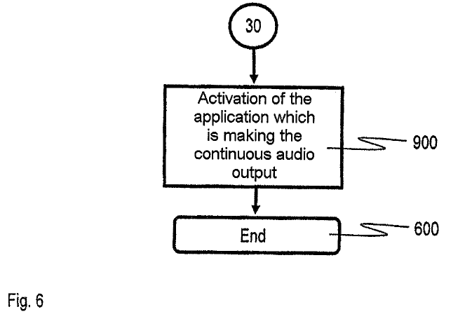

If the checking of the applications 51 to 54 reveals that no application 51 to 54 is active, in step 800 it is checked whether one of the applications 51 to 54 is an active audio application, continuous audio output is made via the audio system 6, for example. If the checking of the applications 51 to 54 in step 800 reveals that one of the applications 51 to 54 is an active audio application, in step 810 the system branches to the node 30 in FIG. 6. As is apparent from FIG. 6, in step 900 the application which makes the continuous audio output is activated. The method is then ended in step 600 up to renewed activation by activation of one of the toggle switches 31, 32.

If the checking of the applications 51 to 54 in step 800 reveals that none of the applications 51 to 54 is an active audio application, in step 820 the system branches to the node 20 in FIG. 4. As is apparent from FIG. 4, the activation of one of the toggle switches 31, 32 which has been detected before the step 100 leads in step 700 to activation of a predefined application, for example the application 51, or to activation of an application which was used last by the applications 51 to 54. Then, the method in step 600 is ended until renewed activation by activation of one of the toggle switches 31, 32.

From the previous statements it is apparent that the toggle switches 31, 32 act either as one-jump switches or as toggle switches depending on the states of the assigned applications 51 to 54.

In an exemplary embodiment which is not illustrated, for example only two audio applications A and B are assigned to a toggle switch. Activation of the toggle switch then activates the respective other audio application A or B if one of the audio applications B or A is active. If A is the active application, the activation of the toggle switch leads, for example, to activation of the application B. If none of the two applications A, B is active, either a predefined application, for example the application A, is activated when the toggle switch is activated or the last activated application is activated again. If none of the two applications A, B is active but one of the two applications A, B is an active audio application, for example the application A is making continuous audio output via the audio system 6, then when activation occurs the active audio application A becomes the active application which is displayed on the screen display 2.

Before switching off occurs, the operating system 1 stores the current system states. The stored system states are then loaded again and set after the operating system 1 has been switched off. In an alternative embodiment (not illustrated), an initial application which is activated after switching on occurs can be defined.

Analogously, an application is defined which is activated after the operating system has been reset or when the operating system is first activated if none of the applications 51 to 54 was yet active at the time when the toggle switch 31, 32 was first activated.

If the application which is to be activated is switched off, the application can either be switched on automatically by activation of the toggle switch 31, 32 or the application can be jumped over or it is displayed that the application is switched off or the toggle switch 31, 32 does not have any function in this case.

The applications 51, 52, 53, 54 includes, for example, a radio application, a disk application, a multimedia application, a navigation application, a video application, a CD application, a DVD application, a TV application, a telephone application, an e-mail application and/or an address book application. The radio application can include various radio devices such as DAB, FM, satellite radio or alternatively the last radio band, for example AM, FM, MW and LW. The disk application includes, for example, all the applications which use a multimedia disk drive such, as for example, CD audio, CD video, DVD audio, DVD video, MP3 CD etc.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. An operating method for a vehicle having at least one toggle switch with which, when it is activated, it is possible to change between at least two assigned applications or application groups, characterized in that after activation of the toggle switch has been detected, activation states of the at least two assigned applications or application groups are determined, and at least one of the assigned applications or application groups is activated as a function of the determined activation states, wherein a predefined basic state of a predefined application or application group or a stored last state of an application or application group which is activated last is set if all the applications or application groups which are assigned to the toggle switch are in a first state.

12. The operating method as claimed in claim 11, characterized in that the first state of an application or application group is detected if the associated application or application group is deactivated, wherein a second state of an application or application group is detected if the associated application or application group is activated, and wherein a third state of an application or application group is detected if the application or application group is an audio application which is making a continuous audio output.

13. The operating method as claimed in claim 12, characterized in that if one of the applications or application groups which is assigned to the toggle switch is in the second state, an application or application group which is arranged in a predefined sequence after the application or application group which is instantaneously activated is activated, wherein the instantaneously activated application or application group is deactivated.

14. The operating method as claimed in claim 12, characterized in that if one of the applications or application groups which is assigned to the toggle switch is in the second state, an application or application group which is arranged in a predefined sequence before the application or application group which is instantaneously activated is activated, wherein the instantaneously activated application or application group is deactivated.

15. The operating method as claimed in claim 12, characterized in that if one of the applications or application groups which is assigned to the toggle switch is in the third state and none of the applications or application groups which is assigned to the toggle switch is in the second state, the application or application group which is in the third state is activated.

16. The operating method as claimed in claim 11, characterized in that the activated application or application group is displayed for operator control on at least one optical display unit.

17. The operating method as claimed in claim 11, characterized in that at least two applications or application groups comprise at least one of a radio application, a disk application, a multimedia application, a navigation application, a video application, a CD application, a DVD application, a TV application, a telephone application, an e-mail application and an address book application.

18. The operating system for a vehicle for carrying out the method as claimed in claim 11, having at least one toggle switch with which it is possible to change between at least two applications or application groups which are assigned to the toggle switch,
characterized by an evaluation and control unit which, after activation of the toggle switch has been detected, determines the state of at least two applications or application groups which are assigned to the toggle switch, and activates at least one of the assigned applications or application groups as a function of the determined activation states of at least two assigned applications or application groups,
wherein the evaluation and control unit sets a predefined basic state of a predefined application or application group or the stored last state of a last activated application or application group if all the applications or application groups which are assigned to the toggle switch are in the first state.

19. The operating system as claimed in claim 18, characterized in that there are two toggle switches which are each assigned the same applications or application groups, wherein a first toggle switch runs through in ascending order the assigned applications or application groups which are arranged in a predefined sequence, and a second toggle switch runs through in descending order the assigned applications or application groups which are arranged in a predefined sequence.

20. The operating system as claimed in claim 18, characterized by a screen display for displaying the activated application or application group, and by an audio system for continuous audio output of an audio application.

21. The operating system as claimed in claim 19, characterized by a screen display for displaying the activated application or application group, and by an audio system for continuous audio output of an audio application.
